(19) United States
(12) Patent Application Publication
(10) Pub. No.: US 2012/0167562 A1
(43) Pub. Date: Jul. 5, 2012

(54) DISPLACEMENT DRIVE

(76) Inventor: Peter John Carter, Yemassee, SC (US)

(21) Appl. No.: 13/392,517

(22) PCT Filed: Aug. 26, 2010
(86) PCT No.: PCT/US10/46752

§ 371 Date: Feb. 25, 2012

(30) Foreign Application Priority Data
Aug. 27, 2009 (AU) 2009904079

(51) Int. Cl. F03B 17/00

(52) U.S. Cl. 60/496

(57) ABSTRACT

A mass displacement drive has at least two corresponding arms and a chamber located at a distal end of each arm, each chamber having a piston moveable therein. A fluid, which may be a gas such as air, enters and exits the chambers at defined intervals to change the buoyancy of the chambers with respect to each other, generating a mass displacement torque to move the arms about the axis.

### FIELD OF THE INVENTION

The present invention relates to a mass displacement drive and in particular to a drive that utilizes the displacement of mass within a system to rotate a shaft to generate energy.

### BACKGROUND OF THE INVENTION

With resources becoming scarce throughout the world and an increased concentration of greenhouse gases in the atmosphere, there has been a focus on renewable energy devices. Renewable energy devices typically utilize nature to generate a force required to turn a shaft or move a piston to generate energy. For example, wind power, wave and tidal power, solar power or the like. Such renewable energy devices must be located in specific locations, are not portable and are expensive to install and operate.

Wind power is limited by its need for a location where the wind is considered reliable. It is rarely constant. The amount of power developed by wind generators varies with wind speed and down time due to the lack of wind on windless days. Wind power also has issues with placement near communities and the concept of ocean based wind power installations suffers from the distance to the nearest electricity grid connection point.

Wave and tidal power installations have not been able to produce a constant power generation due to the nature of the force being used to drive them. Power is only produced intermittently in line with the availability of the waves and tides. Location also forces the use of an expensive underwater cable run to a grid connection point.

Solar power has chosen a different direction where the idea is to produce a larger number of less efficient cells that can be manufactured at a lower cost. This approach requires an expanded footprint for commercial installations.

Accordingly, there is a need for a more suitable, cheap and efficient renewable power generation device.

There is also a need to use constantly available forces which are sustainable. There is a need for a device that is not location dependent and can be scaled to fit a particular application. With commercial scale units, electricity grid connection is a simpler procedure and available at a reduced price as installation costs and complexity are significantly reduced. There is also a need for a device which can be installed in remote locations and can be operated independently, in array or grid connected.

### OBJECT OF THE INVENTION

It is the object of the present invention to substantially overcome or at least ameliorate one or more of the above disadvantages or to provide a useful alternative.

### SUMMARY OF THE INVENTION

A mass displacement drive has at least two corresponding arms and a chamber located at a distal end of each arm, each chamber having a piston moveable therein. A fluid, which may be a gas such as air, enters and exits the chambers at defined intervals to change the buoyancy of the chambers with respect to each other, generating a mass displacement torque to move the arms about the axis.

A shaft may be rotated about the axis when the arms rotate, thereby generating a rotational force for use as energy.

The device may include a plurality of corresponding arms and chambers extending outwardly away from each other and from the base.

The device may include a cam rotatable about the axis. Upon rotation of the arms, the cam moves the chambers and pistons relative to each other to modify buoyancy of the chambers.

As the device rotates, one the chamber moves to a negative buoyant position and a corresponding chamber moves to a positive buoyant position. The chambers and pistons, although in pairs in some embodiments, may operate independently of each other.

### BRIEF DESCRIPTION OF THE DRAWINGS

FIG. 1 is a side view of a first embodiment of the present invention;

FIG. 2 is a side view of a further embodiment of the present invention;

FIG. 3 is a side view of an additional embodiment of the present invention;

and

FIG. 4 is a side view of another embodiment of the present invention.

### DETAILED DESCRIPTION OF THE PREFERRED EMBODIMENTS

In the accompanying drawings there is depicted a mass displacement drive 1 having a base 3 defining a longitudinal axis XX. A pair of corresponding arms 4 extend outwardly away from the base 3.

In one embodiment, the arms 4 are substantially perpendicular to the axis XX along the lines ZZ. A chamber 6 is positioned at or near a distal end of each arm 4 and has a piston 10 moveable relative to, or within, the chamber. The pistons 10 are in communication with each other by way of the arms 4. Movement of the pistons 10 relative to the chambers changes the buoyancy of the chambers 6. Fluid (not shown) is introduced into and removed from the chambers 6, and may move between the chambers 6, altering the weight or buoyancy of each arm 4 and chamber 6 construct, thereby generating a force to rotate the arms 4 and the chambers 6 about the axis XX.

In one embodiment, the base 3 includes a shaft (not shown). The shaft may be rotated about the axis XX when the arms 4 rotate, thereby generating a rotational force that may be harvested, and is useful in generating energy.

In one embodiment the fluid is a gas. The gas may be air. A second fluid may be present within the chambers in their non-buoyant state on the external side of the pistons 10. The second fluid may be a liquid. The liquid may be water.

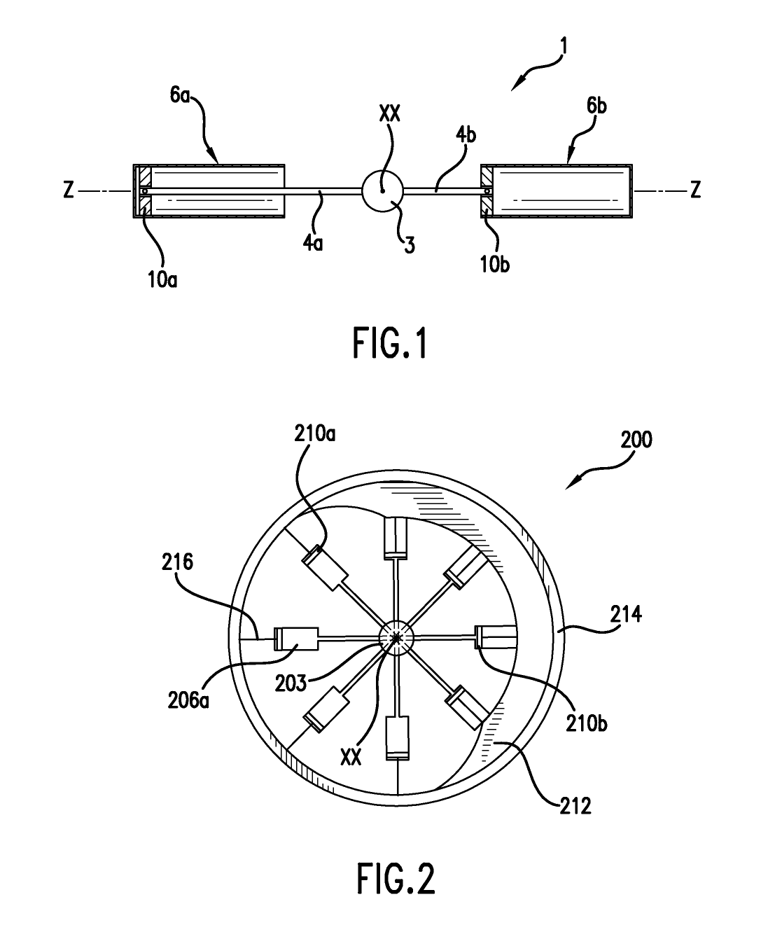

Referring particularly to FIG. 1, in use, displacement of the fluid, such as air, increases mass of chamber 6a and results in a loss of buoyancy and an increase in the moment force derived about axis XX. At the same time, the non-displaced fluid, which may be air, yields a lower effective mass of chamber 6b as compared to chamber 6a, inherently maintaining optimal potential buoyancy.

The chambers 6a, 6b can vary the fluid volume by displacement of the mass within each chamber 6a, 6b, such as by movement of piston 10 which alternately permits and voids the chamber of fluid such as air that decreases the buoyancy. The opposing chambers 6a, 6b are so constructed and designed such that the displacement of fluid within one chamber results in a differential of buoyancy while retaining the original mass. This mass displacement can be designated for rotational, rocker (reciprocating), linear (including vertical), pendulum (harmonic) or circular (orbital) application.

The displacement of the mass of one chamber 6a causes a loss of buoyancy in the chamber 6a and initiates a negative buoyant (non buoyant, or gravity induced) condition under which the chamber 6a must descend. (Mass multiplied by the gravity constant minus the frictional losses minus the entrapped mass). In a rotational application, (FIG. 1) the first arm 4a is constrained at the base 3. The displacement of the mass of the first chamber 6a induces inertia in the arm 4 about axis XX, due to the constraint with the base 3. (Expressed by the equation mass of the first chamber 6a multiplied by the length of the first arm 4a =Torque (T) at the base 3 (or pivot point or axis XX)). The lack of displacement of mass in the second chamber 6b now acts to initiate an ascent in the second chamber 6b. Again, in rotational application (FIG. 1), the second arm 4b is constrained at the base 3. This constraint results in a torque being applied about the axis XX. In the simplified diagram, this induces rotation about axis XX.

In one embodiment, as the first chamber 6a reaches the bottom of its travel (between 15 degrees before and 15 degrees after in a rotational application), by means of a mechanism incorporated within the device 1, the mass of the first chamber 6a is again displaced to the original position. The mechanism could for example be a motor, bellows, valve, hinge, elastic, spring or the like. A mechanism, such as a compressor may supply a compressed gas, which may be compressed air, to displace the piston. This results in the first chamber 6a becoming positively buoyant. This positive buoyancy results in an ascent condition. Due to the constraint at the base 3, this causes a rotational force about the axis XX. The second chamber 6b reaches the top of its travel (between 15 degrees before and 15 degrees after for a rotational application). By means of a mechanism incorporated within the device 1, the mass of the second chamber 6b is again displaced to the maximum position. This results in the second chamber 6b becoming negatively buoyant. This negative buoyancy results in a descent condition, again if constrained at the base 3 this causes a rotational force about the axis XX. Multiple paired mass displacement chambers being fitted to the device 1 act to keep the motion of the drive shaft underway.

The device 1 is sized by a combination of the initial volume of the chambers 6a, 6b and the percentage of volume change along with the moment upon which the mass acts. The paired chambers may be linked via a fluid path within the arms 4 in order to allow the flow of a fluid or mobile media (gas, liquid or mobile solids or fines) between each chamber 6a, 6b during operation.

As best seen in FIG. 2, in one embodiment, the device 200 may include a plurality of arms 204, chambers 206 and pistons 210a, 210b. A cam 212 may be provided within a frame 214. The cam 212 moves the pistons 210b down within the chambers to induce a non buoyant state of the chamber and associated arm. The connecting rods 216 contact the cam surface and move the pistons within the chambers to decrease the volume of the gas filled chamber and decrease buoyancy. The chamber may fill with a fluid, which may be a liquid such as water, from a top opening of the chamber when the device is submerged in a fluid such as a liquid. In another embodiment, as an alternative, the cam pushes the chambers along the arms 204 and relative to the pistons to create a buoyant chamber. The cam 212 also helps the pistons 210 push the fluid towards the opposing chamber 206. The fluid flowing between the chambers 4 and through the hollow arms 204 could all be connected, or conduits may be located in the arms for fluid transfer. The pistons may comprise sealing rings, such as are commonly used with pistons that reciprocate within chambers such as cylinders. The rings may be o-rings.

In FIGS. 1 and 2, the direction of rotation created by the negatively buoyant chambers produces a motion of the device. In this example, because the chambers 206 are arranged in a circular pattern with a pivot point (axis XX) in the centre of the connecting arms 204, the positively buoyant chambers 206 generate a torque during ascent. The negatively buoyant chamber also generates torque during descent. This combination of forces causes the device 200 to rotate.

In FIGS. 1 and 2, the direction of rotation created by the positively buoyant chambers reinforces the motion of the device. By reversing the orientation of the chambers 6 the device will rotate in an opposite direction. The amount of energy produced is a factor of the length of the arms by the sum of the mass of the mass displacement chambers. The device is designed to produce power in both phases, the disposition of the mass over the available buoyancy is designed to allow the maximum gain from both phases.

In a preferred embodiment, the pistons move independently. More specifically, the piston of chamber 206a moves independently of corresponding piston 210b. Further, the piston is timed to move independently of corresponding piston 210b. In this embodiment, the upwardly moving chamber 206a is timed so that as its piston is moved within chamber 206a, the chamber changes from the buoyant state to the non buoyant state within a range of 30° before top dead center (BTDC) and top dead center (TDC), The corresponding downwardly moving chamber 206b is timed so that the piston is moved within the chamber so that chamber changes from the non-buoyant state to the buoyant state within a range of bottom dead center (BDC) and 30° after bottom dead center (ABDC). Timing of the piston movement according to this embodiment may be accomplished by appropriate cam geometry, such as by appropriate modification of the cam structure shown in FIG. 2. In one embodiment, the timing of the piston movement to achieve effective buoyancy occurs after the chamber reaches bottom dead center, but before the chamber reaches 30° after bottom dead center, while timing of the piston movement to achieve negative buoyancy effectively occurs just prior to the chamber reaching top dead center.

Alternatively, timing of the piston movement according to the embodiment of the prior paragraph may be accomplished with a fluid, which may be air, that is introduced under pressure into the chamber to cause movement of the piston, creating buoyancy in the chamber. The fluid may be evacuated to move the piston in the opposite direction, and create a non-buoyant state of the chamber. The pressurized fluid may be introduced and evacuated to achieve the timing of the piston movement according to this embodiment. The fluid may be introduced by a pump. The pump may be an electrically powered compressor, which may be an air compressor, that supplies pressurized air or other gas to the piston to move the piston within the chamber.

Alternatively, the timing may be achieved by a combination of cam geometry as described and the use of a pressurized fluid as described.

In another embodiment, each chamber does not correspond to another chamber. For example, in the rotary embodiment of FIG. 2, an odd number of chambers may each extend from an arm. With an odd number of chambers and pistons, the chambers are preferred to be equally spaced in the rotary embodiment. For example, if five chambers and arms are present, the chambers would be spaced at about 72° intervals, while nine chambers and arms would be spaced at about 40° intervals. Whether an odd or equal number of chambers are used, the chambers and arms may be equally spaced apart in the rotary embodiment of FIG. 2.

In a preferred embodiment, the pistons draw air or other gas into the chamber to effect positive buoyancy. An air reservoir of receiver has an available supply of air. The center hub 203, 303 or center area of the device may provide such a reservoir, with the arms acting as a conduit or providing a conduit within the arms to communicate between the reservoir and the chamber. Movement of the piston creates a drop in pressure that draws air into the chamber. Movement of the piston may be effected by pneumatic means, or by a pneumatic or hydraulic cylinder, or by an electric motor having gearing such as a worm gear or similar mechanical linkage to actuate the piston to draw air into the cylinder. Spring biasing may be used to assist movement of the piston. The device may also be used to expel air or gas from the piston to effect negative buoyancy, although the cam structure described herein may also be used to move the piston relative to the cylinder. In another embodiment, either the piston and/or another device, such as a motorized pump, create a vacuum in the chamber to effect positive buoyancy of the chamber.

In a preferred embodiment as shown in FIG. 2, the pistons move relative to the cylinders. In another embodiment, the cylinders may move relative to the pistons and arms to alternatively increase the volume of the gas chamber and increase buoyancy and decrease the volume of the gas chamber and decrease buoyancy.

Mass displacement chambers, which are negatively buoyant, are in the descent phase, while the opposing mass displacement chambers that is positively buoyant is in the ascent phase. When the mass displacement chambers are arranged in a circular pattern with a pivot point (axis XX) in the centre of the connecting arms, the negatively buoyant chambers generate a torque during its descent, as does the positively buoyant chambers during its ascent. This forces the device to rotate.

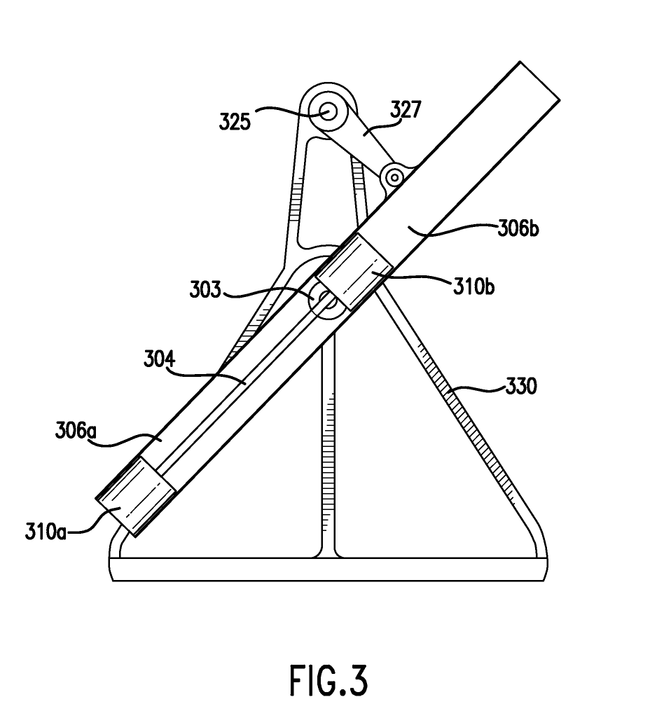

In FIG. 3, an alternate system is shown whereby the base 3 and axis XX move, thereby creating a different rotational axis. This embodiment includes paired chambers 306a, 306b linked 180 degrees opposed, where the length of displacement is controlled by moving the arm 304 to favour first one chamber 306a then the other chamber 306b. Thus causing an offset in the moment arm 304, allowing the mass displacement device 300 to ascend or descend.

In FIG. 3, both chambers 6a, 6b remain positively buoyant and torque is affected directly by the displacement of the buoyant mass. The resultant torque reacts at the pivot point or base 303 and is translated to the crankshaft 325 by the connecting rod 327. The crankshaft 325 is held by a frame 330.

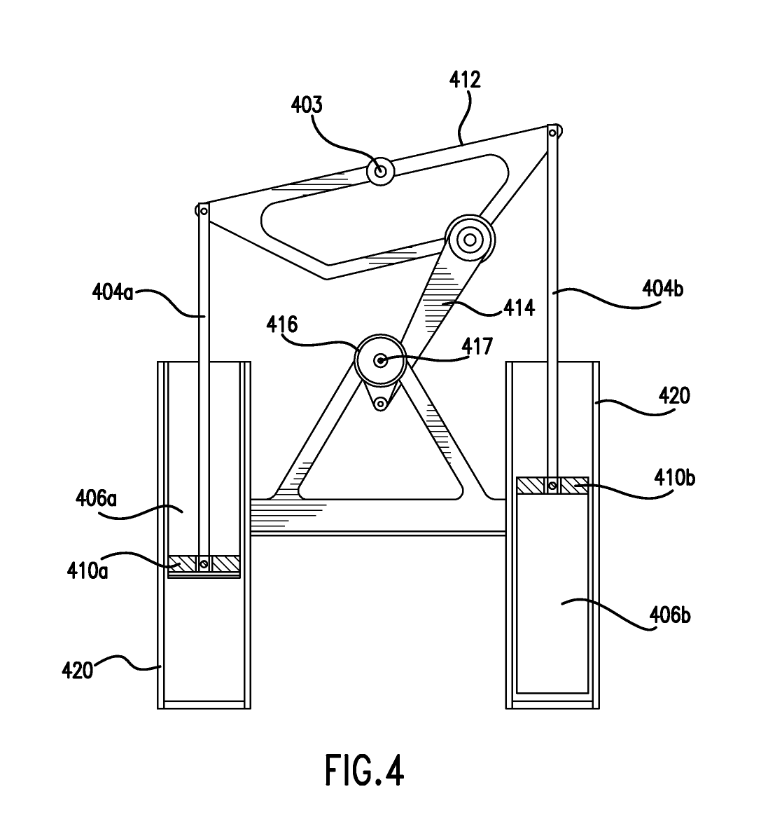

Whilst FIGS. 1 and 2 show a radial pattern device, the device can be built as a linear pair, moving in a vertical plane for both descent and ascent as shown in FIG. 4. In this case the device 400 is constructed using a pair of arms 404 to provide the buoyant media, such as a pair of tubes or tanks, either installed above or below ground. The linear variation (torque arm length) would be a product of the distance separating the two linear assemblies.

In use, there are a number of chambers 406 (cylinders or the like), which act as the mass displacement chambers 406a, 406b and may be arranged in pairs that are 180 degrees opposed. These opposed chambers may be linked via hollow connecting arms or rods 404 giving them the ability to allow fluids such as air, other gases or liquids to flow therethrough. As one chamber 6 moves to a negatively buoyant position, it forces the opposing chamber 6 to increase its volume, thus increasing its buoyancy.

When mass is displaced by linear movement of the paired mass displacement chambers the positively buoyant chambers generate the same force thus creating the torque to drive the device.

FIG. 4 illustrates a pair of chambers 406a, 406b for a vertical installation. This embodiment is a pivoted rocker design. Where depth constraints prohibit the operation of radial designs, the device 400 can function as a rocker design coupled to a crank 416 in order to generate the required rotation.

In FIG. 4, the mass displacement chambers 406a, 406b are mounted vertically, such that the vertical movement of both arms 404a and 404b effect a movement in the rocker arm 412 located at the base 403. The base 403 being the center pivot. The resulting movement of the rocker arm 412 is translated via a connecting rod 414 to a crankshaft 416 or the like to rotate a shaft 417. The chambers 406a, 406b can be located within housings 420.

The device may be operationally described by energy balance. Three energy values are calculated for each revolution of the device:
A. The energy put into the device to drive the pistons in the chambers, which is given by:
   W=(Pressure on chamber at bottom)×(end area of chamber)×(length of chamber)
B. The energy lost in operation through the drag on the chambers moving through liquid, such as water, which is given by:

Drag Force×Distance Moved=½ ηAC_{d}u²s

Where η is the density of a liquid, such as water, A is the projected area of the chamber, C_{d} is the drag coefficient, u is the velocity of the chambers, and s is the distance through which they move.
C. The energy produced by the buoyancy of the gas or air filled chambers, which is given by:
   F=(displaced volume of liquid)×(density of liquid)×(vertical movement)

If the device is theoretically valid, then:

Energy from the gas or air filled chambers>energy in the drag+energy to operate chambers, or

C>B+A

Modeling indicates that the device is theoretically valid.

A preferred mode of use for the device is the generation of power. A preferred mode use of power derived from this device is to drive electricity (AC or DC) generators, which could augment existing power supplies, be connected to an electricity grid, or used independently to directly power remote or individual sites such as farms, rural and industrial properties, resorts, commercial and residential complexes, or other users of power.

The device may be used for distributed power generation to augment or replace base load power supply to an existing electricity network. There is the ability to install small independent devices in household or residential situations, and any unused power may be supplied back to an electrical grid, or shared in local community network connections.

Because the device produces raw power, it may be used to power other applications by direct means. It is possible to power such applications as reverse osmosis (desalination) units to produce potable water. Major users of electricity such as Aluminium production, metals refining and chemicals plants, would benefit from independent, on-site power plant installations.

Transport systems may use the device, such as for direct propulsion applications within the maritime industry to power surface and submerged vessels. Trucks, cars and other vehicles, trains, airplanes and other transport systems may use the device either directly to drive the transportation, as a mobile supplement supply to transport battery systems, or as a standalone or networked source of electricity to supply single or multiple battery powered transport systems.

The device of the present invention harnesses the effect of varying the mass of the mass displacement chambers relative to their effective centre of rotation (axis XX) thus allowing the descent and ascent characteristics of buoyancy and negative buoyancy, positive and negative states of gravity, to be used as a drive method.

It is preferred that the device according to each embodiment is submerged in a fluid. The fluid may be a liquid. The liquid may be water. The liquid may comprise anti-corrosion agents and/or lubricants. The device is preferred to be submerged in the fluid to at least a level that will fill the chambers to negate buoyancy by the water surrounding the chambers. The fluid level may extend from the bottom of a base for the device to above the highest level of the chambers. For the device as shown in FIG. 2, the fluid level is preferred extend above the top of the chamber that is at the top of the rotation cycle. In FIG. 4, fluid will enter 406a from the top of the chamber to push the piston down as 406b fills with a gas to push the piston up.

This device once installed is not dependent on available conditions such as solar, wind, wave or tidal power or the like. The device operates substantially independently of the environmental conditions in which it is located.

The device is not dependent upon its location or orientation to operate efficiently and can be mounted on a moving platform, vehicle, vessel, train, airplane or other transport.

The device does not require unique materials, like solar films, to operate effectively and can be manufactured from metal, minerals, plastic, composite or natural materials, or a combination of these, to achieve the operating properties of the device 1.

The device has the ability to function subsea in varying depths of water and to function in a manufactured or constructed environment such as the vertical installation and vary the cycle to suit the environment and power generation needs.

This invention is primarily a mechanical device, which uses the displacement of the mass of any or all components, whether that be linear displacement or displacement achieved by varying the volume of that mass, that forms the operational core of the device to alter either the mass distribution, or affect both the positive and negative states of buoyancy or gravity.

This alteration of mass distribution is then capable of creating a rotating or linear motion, or a combination of rotation and linear motion, which may be converted through mechanical, hydraulic, pneumatic or other means for the purpose of creating a mass displacement drive system. The drive system may be used to power any application normally associated with conventional fossil fuel engines, motors, or renewable, or allowable energy systems. The applications of this drive in principal functions in air, or in a combination of water (sea or fresh water), or other liquids and in differential gaseous environments, whether atmospheric or artificially created. The operation of any adaptation of this drive relies on the drive mass units achieving a differential effect thus generating a force.

Although the invention has been described with reference to specific examples, it will be appreciated by those skilled in the art that the invention may be embodying many other forms.

What is claimed is:

1. A mass displacement drive comprising;
a first arm that communicates with an axis and a second arm positioned opposite the axis from the first arm, wherein the second arm communicates with the axis;
a first chamber located at a distal end of the first arm and a second chamber located at a distal end of the second arm, the first chamber comprising a first piston movable therein and the second chamber comprising a second piston moveable therein
wherein, in use, movement of the first piston draws fluid into the first chamber to increase buoyancy of the first chamber while movement of the second piston forces fluid from second chamber to decrease buoyancy of the second chamber, with the change in mass of the first chamber relative to the second chamber generating a mass displacement torque to move said arms about said axis.

2. A mass displacement drive as described in claim 1, wherein, subsequent to the first piston drawing fluid into the first chamber to increase buoyancy of the first chamber while the second piston forces fluid from second chamber to decrease buoyancy of the second chamber, movement of the second piston in an opposite direction draws fluid into the second chamber to increase buoyancy of the second chamber while movement of the first piston in an opposite direction forces fluid from first chamber to decrease buoyancy of the first chamber, with the change in mass of the first chamber and the second chamber generating a mass displacement torque to move said arms about said axis.

3. A mass displacement drive as described in claim 1 or 2, further comprising a shaft, said shaft being rotated about said axis by movement of the arms about the axis, thereby generating a rotational force.

4. A mass displacement drive as described in claim 1, 2 or 3, further comprising a plurality of corresponding arms and chambers extending outwardly away from each other and said base.

5. A mass displacement drive as described in claim 1, 2, 3 or 4, further comprising a cam that communicates with the first piston and the second piston to move the first piston within the first chamber and to move the second piston within the second chamber.

6. A mass displacement drive as described in claim 1, 2, 3, 4, or 5 further comprising a cam whereby upon rotation of said arms said cam moves said chambers along said arms towards and away from said axis.

7. A mass displacement drive as described in claim 1, 2, 3, 4, 5 or 6, said first chamber and said second chamber being in communication with each other by way of said arms.

8. A mass displacement drive as described in claim 1, 2, 3, 4, 5, 6 or 7, wherein said first arm and said second arm extend outwardly from said axis and rotate about said axis.

9. A mass displacement drive as described in claim 1, 2, 3, 4, 5, 6, 7 or 8, wherein said first piston and said second piston are in communication with each other by way of said arms.

10. A mass displacement drive as described in claim 1, 2, 3, 4, 5, 6, 7, 8 or 9, wherein the first chamber and the second chamber rotate about the axis, and the first chamber and the second chamber alternate between a buoyant state and a non buoyant state as the first chamber and the second chamber rotate, and the first chamber and the second chamber change from a buoyant state to a non buoyant state within a range of 30° before top dead center and top dead center, and the first chamber and the second chamber change from a non-buoyant state to a buoyant state within a range of bottom dead center and 30° after bottom dead center.

11. A mass displacement drive as described in claim 1, 2, 3, 4, 5, 6, 7, 8, 9, or 10, wherein the fluid is a gas.

12. A mass displacement drive as described in claim 1, 2, 3, 4, 5, 6, 7, 8, 9, or 10, wherein the fluid is air.

13. A mass displacement drive as described in claim 1, 2, 3, 4, 5, 6, 7, 8, 9, 10, 11 or 12, wherein the first chamber and the second chamber are submerged in a liquid.

14. A mass displacement drive as described in claim 1, 2, 3, 4, 5, 6, 7, 8, 9, 10, 11 or 12, wherein the first chamber and the second chamber are submerged in water.
